(19) United States
(12) Patent Application Publication
(10) Pub. No.: US 2011/0085912 A1
(43) Pub. Date: Apr. 14, 2011

(54) PROPELLER FOR A WIND MOTOR

(76) Inventors: Göran Nilsson, Sandarne (SE); Gun Persson, Ljusne (SE); Eva Zamel, Ljusne (SE); Rolf Nilsson, Sandarne (SE)

(21) Appl. No.: 12/602,294

(22) PCT Filed: May 30, 2008
(86) PCT No.: PCT/SE2008/050635

§ 371 Date: Apr. 7, 2010

(30) Foreign Application Priority Data
May 31, 2007 (SE) 0701311-3

(51) Int. Cl. F03B 3/12

(52) U.S. Cl. 416/241 R

(57) ABSTRACT

A propeller (1) for a wind motor (12), wherein:
the propeller (1) is rotatable about a rotation axis (2) which is inclined by an angle of essentially 45 degrees with respect to the horizontal plane,
the propeller (1) has at least two propeller blades (3), each of which having a blade axis (4) extending perpendicularly from the rotation axis (2), and
each one of said propeller blades (3) has a front side (5) and a rear side (6), the front side (5) being intended to face towards the wind during at least a part of a revolution about the rotation axis (2), wherein each one of said propeller blades (3) is inclined by an angle of essentially 45 degrees with respect to the rotation axis (2).

### FIELD OF THE INVENTION AND PRIOR ART

The invention relates to a propeller according to the preamble of claim 1 and a wind power plant according to the preamble of claim 9.

The most commonly occurring high momentum turbines, rotating with low rotational speed, are rotor turbines. The rotor turbines have the benefit of having a simple and cost-effective structure. The efficiency of these rotor turbines is, however, negatively affected by the fact that the surface or surfaces of the rotor intended to utilize the dynamic force of the wind and being moved in the wind direction, correspond to inactive surfaces forced to move against the wind direction, thus providing a braking effect in the rotor turbine. Different methods to reduce this braking effect, thus increasing the efficiency, have been proposed, but these methods generally involve a more complex turbine construction.

CH 695790 A5 describes an arrangement in which the rotation axis of a propeller of a wind power plant is arranged in an inclined position with respect to the horizontal plane.

### SUMMARY OF THE INVENTION

The object of the present invention is to provide a new and favourable propeller for a wind motor as well as a new and favourable wind power plant.

This object is according to the invention achieved by means of a propeller having the features defined in claim 1 and a wind power plant having the features defined in claim 9.

According to the invention:
the propeller is rotatable about a rotation axis which is inclined by an angle of essentially 45 degrees with respect to the horizontal plane,
the propeller has at least two propeller blades, each of which having a blade axis extending perpendicularly from the rotation axis,
each one of said propeller blades has a front side and a rear side, the front side being intended to face towards the wind during at least a part of a revolution about the rotation axis, and
each one of said propeller blades is inclined by an angle of essentially 45 degrees with respect to the rotation axis.

In the propeller arrangement described above, each one of the propeller blades will, on its front side, capture the wind in an angle between 0 and 90 degrees. Since the rotation axis is inclined by an angle of essentially 45 degrees with respect to the horizontal plane and the propeller blades are inclined by an angle of essentially 45 degrees with respect to the rotation axis, each one of the propeller blades in the propeller will at one point of a complete revolution about the rotation axis be positioned with its front side inclined essentially 90 degrees with respect to the wind. Due to the inclination of the rotation axis, the propeller blade in this position travels with the wind. Thus, when the propeller blade is in this position a maximum amount of the force from the wind is transferred to a rotational force on the propeller by the propeller blade. During the rest of the complete revolution, each one of the blades is inclined by an angle ranging from 0 to <90 degrees with respect to the wind. In the position where a propeller blade is inclined by an angle of essentially 0 degrees with respect to the horizontal plane, the propeller blade is travelling against the wind due to the inclination of the rotation axis with respect to the horizontal plane. The propeller rotation braking energy is minimized because each one of the propeller blades meets the wind with the edge of the propeller blade when travelling against the wind.

According to one embodiment of the invention the propeller blades are arranged in pairs, the two propeller blades in each pair being arranged opposite to each other on opposite sides of the rotation axis and being inclined by an angle of essentially 90 degrees with respect to each other. At the moment when one of the propeller blades in a pair of propeller blades is inclined by an angle of 0 degrees with respect to the wind, that specific blade will not contribute significantly to the transfer of the force from the wind to a rotational force on the propeller. However, the other propeller blade in the pair of propeller blades will at that moment be inclined by an angle of essentially 90 degrees with respect to the wind, which means that the force from the wind is always transferred to a rotational force on the propeller at all time during a complete revolution.

According to another embodiment of the invention the front side of each one of the propeller blades has a flat or concave shape. Hereby, the propeller blade has an ideal shape for capturing the force from the wind.

According to another embodiment of the invention the rear side of each one of the propeller blades has a convex shape. By this, the profile of each one of the propeller blades will be similar to the profile of a wing of an aeroplane, with one side essentially flat or concave and the other side essentially convex. If an air stream, such as a wind, passes parallel to such a propeller blade, a negative pressure will be created on the convex side, i.e. the rear side of the propeller blade, which results in a force perpendicular to the propeller blade and directed towards the front side of the propeller blade, hence contributing to the rotation of the propeller.

According to another embodiment of the invention the propeller blades are attached to a propeller shaft, the propeller shaft being supported by a support element, which is rotatable about a vertical axis so as to allow the propeller to be positioned towards the wind. Due to occasional changes in the wind direction it is advantageous if the propeller can be directed towards the wind so as to transfer the energy in the wind to rotational energy of the propeller as efficient as possible. A rotatable support element, comprising e.g. a pillar, a housing or any support element suitable for the arrangement, will provide means for adjustment of the propeller towards the wind.

According to another embodiment of the invention a steering board is vertically arranged on the support element, the steering board projecting from the support element, on the side facing away from the propeller blades. The steering board is intended to be arranged parallel to the wind. If the wind changes direction the steering board strives to become parallel with the wind again, hence rotating the support element to a position where the steering board is arranged parallel to the wind, thus arranging the propeller directly towards the wind.

According to another embodiment of the invention a vertically extending compensation member is secured to the support element, wherein each one of the propeller blades during a complete revolution about the rotation axis is arranged to be inclined by an angle of essentially 90 degrees with respect to the horizontal plane at one point of the revolution on a first side of a vertical plane extending along the rotation axis, and is arranged to be inclined by an angle of essentially 0 degrees with respect to the horizontal plane at one point of the revolution on an opposite second side of said vertical plane, the compensation member being arranged on the second side said vertical plane perpendicular thereto. When a propeller according to the invention is used in a wind motor, the force on the propeller blade which at a specific moment is inclined by an angle of essentially 90 degrees towards the wind might be strong enough to rotate the support element about its vertical axis. During operation of the propeller this may lead to wobbling of the propeller. To avoid the aforementioned problem a compensation member is mounted vertically on the side of the propeller opposite to the side where the propeller blades are inclined by an angle of essentially 90 degrees towards the wind. The compensation member is supported by the support element and will compensate for the rotation of the support element caused by the aforementioned force exerted by the wind on the propeller blade which is inclined by an angle of essentially 90 degrees towards the wind, by exerting a rotational force on the support element in the opposite direction to the aforementioned rotational force.

The invention also relates to a wind power plant comprising a wind motor with a propeller according to the invention

Other advantages and advantageous features of the invention will appear from the dependent claims and the subsequent description.

### BRIEF DESCRIPTION OF THE DRAWINGS

With reference to the appended drawings, below follows a specific description of embodiments of the invention cited as examples.

In the drawings:

FIG. 1 shows a very schematic perspective view of a wind motor with a propeller according to the invention,

FIG. 2 shows a schematic image of how the wind affects a propeller blade inclined 0 degrees with respect to the wind,

FIG. 3 shows a schematic image of how the wind affects a propeller blade inclined 90 degrees with respect to the wind,

FIG. 4 shows a schematic image of how the wind affects a propeller blade inclined 45 degrees with respect to the wind, and

FIG. 5 shows a schematic lateral view of a pair of propeller blades arranged opposite to each other on opposite sides of the rotation axis.

### DETAILED DESCRIPTION OF PREFERRED EMBODIMENTS OF THE INVENTION

Explained herein are preferred embodiments of the invention, describing the propeller and the wind power plant of the invention. The invention may, however, be embodied in many different forms and should not be construed as being limited to the exemplary embodiments set forth herein; rather, these embodiments are provided so that this disclosure will be thorough and complete, and will fully convey the concept of the invention to those skilled in the art.

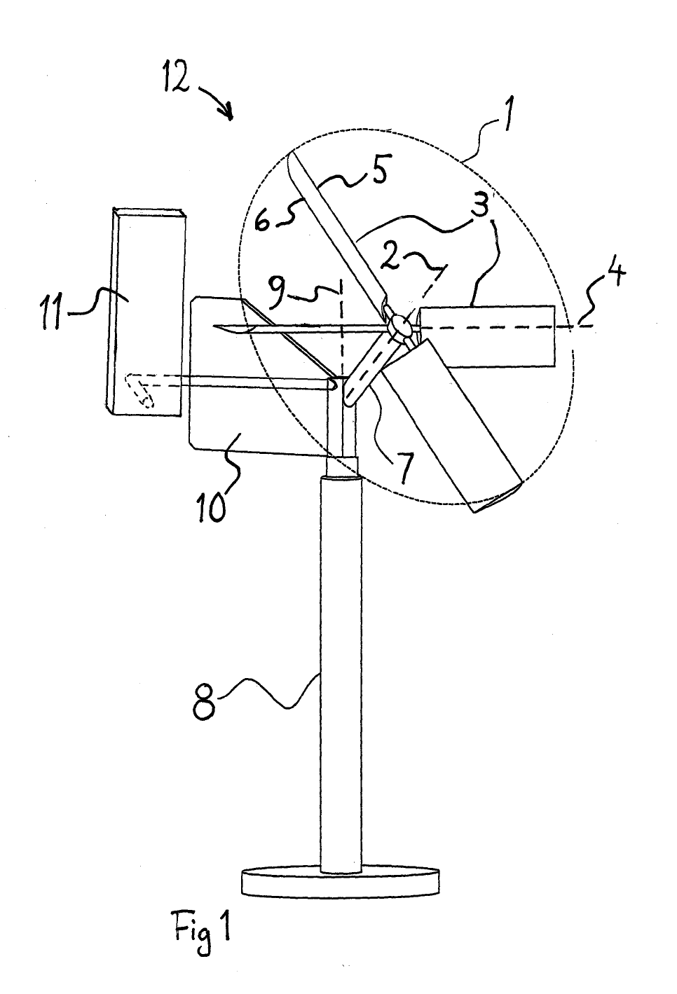

A propeller 1 according to the invention is very schematically shown in FIG. 1. The propeller 1 comprises propeller blades 3, in which each one of the propeller blades 3 a blade axis 4 is located. Each one of the propeller blades 3 is arranged with the blade axis 4 extending perpendicularly from a rotation axis 2. The rotation axis 2 is inclined by an angle of essentially 45 degrees with respect to the horizontal plane. The propeller blades 3 have a front side 5 and a rear side 6, the front side 5 being intended to face towards the wind during at least a part of a revolution about the rotation axis 2 and each one of said propeller blades 3 is inclined by an angle of essentially 45 degrees, preferably in the range of 45-47 degrees, with respect to the rotation axis 2. The propeller blades 3 are attached to a propeller shaft 7, which is attached to a support element 8, here embodied as a pillar. The support element 8 can of course be a housing or any other type of support element. The support element 8 can optionally be rotatable about its vertical axis 9 so as to arrange the propeller 1 in the direction of the wind. A steering board 10 is vertically arranged on the support element 8, the steering board 10 projecting from the support element 8 on the side facing away from the propeller blades 3, so as to steer the propeller 1 towards the wind. A vertically extending compensation member 11 is secured to the support element 8. Each one of the propeller blades 3 during a complete revolution about the rotation axis 2 is arranged to be inclined by an angle of essentially 90 degrees with respect to the horizontal plane at one point of the revolution on a first side of a vertical plane extending along the rotation axis 2, and is arranged to be inclined by an angle of essentially 0 degrees with respect to the horizontal plane at one point of the revolution on an opposite second side of said vertical plane. The compensation member is arranged on the second side of said vertical plane perpendicular thereto.

Due to occasional changes in the wind direction it is advantageous if the propeller 1 can be directed towards the wind so as to transfer the energy in the wind to rotational energy on the propeller 1 as efficient as possible. A rotatable support element 8, here comprising a pillar, will provide means for adjustment of the propeller 1 towards the wind. The steering board 10 is intended to be arranged parallel to the wind. If the wind changes direction the steering board 10 strives to become parallel with the wind again, hence rotating the support element 8 to a position where the steering board 10 is arranged parallel to the wind, thus arranging the propeller 1 directly towards the wind. When a propeller 1 according to the invention is used in a wind motor 12, the force on the propeller blade 3 which at a specific moment is inclined by an angle of essentially 90 degrees towards the wind might be strong enough to rotate the support element 8 about its vertical axis 9. During operation of the propeller 1 this may lead to wobbling of the propeller 1. To avoid the aforementioned problem a compensation member 11 is mounted vertically on the side of the propeller 1 opposite to the side where the propeller blades 3 are inclined by an angle of essentially 90 degrees towards the wind. The compensation member 11 is supported by the support element 8 and will compensate for the rotation of the support element 8 caused by the aforementioned force exerted by the wind on the propeller blade 3 which is inclined by an angle of essentially 90 degrees towards the wind, by exerting a rotational force on the support element 8 in the opposite direction to the aforementioned rotational force.

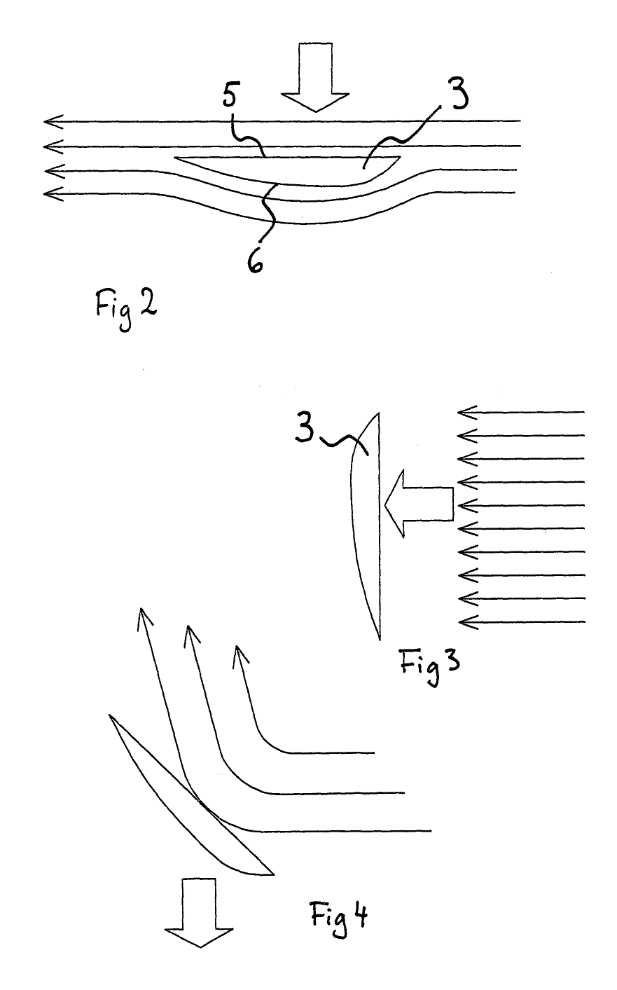

During operation of the propeller 1 each one of the propeller blades 3 will at one point of a complete revolution about the rotational axis 2 meet the wind with its edge, i.e. inclined by an angle of essentially 0 degrees with respect to the horizontal plane. FIG. 2 shows a schematic image of how the wind affects a propeller blade 3 inclined by an angle of 0 degrees with respect to the wind. The thin arrows show how the wind passes the propeller blade 3. Since the path of the air passing on the rear side 6 of the propeller blade 3 is longer than the path for the air passing on the front side 5 of the propeller blade 3, due to the convex shape of the rear side 6 of the propeller blade 3, a negative pressure is created at the rear side 6 of the propeller blade 3, resulting in a force, illustrated by the large arrow, perpendicular to the propeller blade 3 and directed towards the front side 5 of the propeller blade 3, hence contributing to the rotation of the propeller 1.

Each one of the propeller blades 3 will also at one point of a complete revolution about the rotation axis 2 be essentially perpendicularly directed towards the wind, i.e. inclined by an angle of essentially 90 degrees with respect to the horizontal plane. FIG. 3 shows a schematic image of how the wind affects a propeller blade 3 inclined by an angle of essentially 90 degrees with respect to the wind. In this position a maximum amount of the force provided by the wind, shown as thin arrows in FIG. 3, is caught by the propeller blade 3 and transferred to a rotational force, shown as a large arrow in FIG. 3, on the propeller 1.

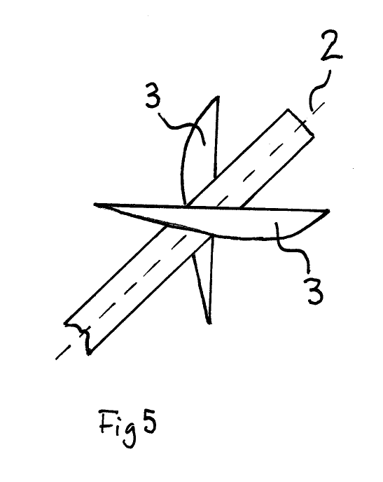

FIG. 4 shows a schematic image of how the wind affects a propeller blade 3 inclined by an angle of 45 degrees with respect to the wind. A force from the wind, represented as thin arrows on FIG. 4, is by a propeller blade 3 positioned according to FIG. 4, transferred to a rotational force, represented by a large arrow in FIG. 4, on the propeller 1.

FIG. 5 shows a schematic view of a pair of propeller blades 3 being arranged opposite to each other on opposite sides of the rotation axis 2. The angle between the two propeller blades 3 in the pair of propeller blades 3 is in this view essentially 90 degrees.

The invention is of course not in any way limited to the embodiments described above. On the contrary, several possibilities to modifications thereof should be apparent to a person skilled in the art without departing from the basic idea of the invention as defined in the appended claims.

1. A propeller (1) for a wind motor (12), wherein:
the propeller (1) is rotatable about a rotation axis (2) which is inclined by an angle of essentially 45 degrees with respect to the horizontal plane,
the propeller (1) has at least two propeller blades (3), each of which having a blade axis (4) extending perpendicularly from the rotation axis (2),
each one of said propeller blades (3) has a front side (5) and a rear side (6), the front side (5) being intended to face towards the wind during at least a part of a revolution about the rotation axis (2), and
each one of said propeller blades (3) is inclined by an angle of essentially 45 degrees with respect to the rotation axis (2).

2. A propeller (1) according to claim 1, wherein the propeller blades (3) are arranged in pairs, the two propeller blades (3) in each pair being arranged opposite to each other on opposite sides of the rotation axis (2) and being inclined by an angle of essentially 90 degrees with respect to each other.

3. A propeller (1) according to claim 1, wherein the front side (5) of each one of the propeller blades (3) has a flat or concave shape.

4. A propeller (1) according to claim 1, wherein the rear side (6) of each one of the propeller blades (3) has a convex shape.

5. A propeller (1) according to claim 1, wherein the propeller (1) has four propeller blades (3).

6. A propeller (1) according to claim 1, wherein the propeller blades (3) are attached to a propeller shaft (7), and the propeller shaft (7) is supported by a support element (8), which is rotatable about a vertical axis (9) to allow the propeller (1) to be positioned towards the wind.

7. A propeller (1) according to claim 6, wherein a steering board (10) is vertically arranged on the support element (8), the steering board (10) projecting from the support element (8) on the side facing away from the propeller blades (3).

8. A propeller (1) according to claim 6, wherein a vertically extending compensation member (11) is secured to the support element (8), each one of the propeller blades (3) during a complete revolution about the rotation axis (2) is arranged to be inclined by an angle of essentially 90 degrees with respect to the horizontal plane at one point of the revolution on a first side of a vertical plane extending along the rotation axis (2), and is arranged to be inclined by an angle of essentially 0 degrees with respect to the horizontal plane at one point of the revolution on an opposite second side of said vertical plane, the compensation member (11) being arranged on the second side of said vertical plane perpendicular thereto.

9. A wind power plant comprising a wind motor (12), wherein the wind motor is provided with a propeller (1) according to claim 1.

10. A propeller (1) according to claim 7, wherein a vertically extending compensation member (11) is secured to the support element (8), each one of the propeller blades (3) during a complete revolution about the rotation axis (2) is arranged to be inclined by an angle of essentially 90 degrees with respect to the horizontal plane at one point of the revolution on a first side of a vertical plane extending along the rotation axis (2), and is arranged to be inclined by an angle of essentially 0 degrees with respect to the horizontal plane at one point of the revolution on an opposite second side of said vertical plane, the compensation member (11) being arranged on the second side of said vertical plane perpendicular thereto.

11. A propeller (1) according to claim 2, wherein the front side (5) of each one of the propeller blades (3) has a flat or concave shape.

12. A propeller (1) according to claim 11, wherein the rear side (6) of each one of the propeller blades (3) has a convex shape.

13. A propeller (1) according to claim 3, wherein the rear side (6) of each one of the propeller blades (3) has a convex shape.

14. A propeller (1) according to claim 2, wherein the rear side (6) of each one of the propeller blades (3) has a convex shape.

15. A propeller (1) according to claim 14, wherein the propeller (1) has four propeller blades (3).

16. A propeller (1) according to claim 13, wherein the propeller (1) has four propeller blades (3).

17. A propeller (1) according to claim 12, wherein the propeller (1) has four propeller blades (3).

18. A propeller (1) according to claim 11, wherein the propeller (1) has four propeller blades (3).

19. A propeller (1) according to claim 10, wherein the propeller (1) has four propeller blades (3).

20. A propeller (1) according to claim 4, wherein the propeller (1) has four propeller blades (3).
